(19) United States
(12) Patent Application Publication
(10) Pub. No.: US 2022/0270101 A1
(43) Pub. Date: Aug. 25, 2022

(54) ADAPTIVE ANTI-MONEY LAUNDERING (AML) TRANSACTION PROCESSING

(71) Applicant: eBOS Technologies, Nicosia (CY)

(72) Inventors: Loizos Christofi, Nicosia (CY); Stelios Christofi, Nicosia (CY); Fanos Christofi, Nicosia (CY)

(73) Assignee: eBOS Technologies, Nicosia (CY)

(21) Appl. No.: 17/668,433

(22) Filed: Feb. 10, 2022

(30) Foreign Application Priority Data
Feb. 12, 2021 (FR) FR2101373

(51) Int. Cl. G06Q 20/40

(52) U.S. Cl. CPC G06Q 20/4016

(57) ABSTRACT

An adaptable anti-money laundering (AML) transaction analysis includes classifying different reviewers according to experience recorded in connection with reviewing financial transactions and determining a capacity for different reviewers. A transaction is received and a primary AML test selected for the transaction. The primary AML test is applied to the transaction and, in response to a failure of the primary AML test, a magnitude of failure is computed along with a degree of expertise required to review the transaction based upon the computed magnitude. A triage rule is applied to the computed magnitude and required degree of expertise and the capacity of the reviewers classified with a degree of expertise equal to or greater than the required degree to determine whether or not to subject the transaction to a secondary AML test, or to queue the transaction for review by one of the reviewers having the required degree of expertise.

### BACKGROUND OF THE INVENTION

This application claims priority under 35 U.S.C. § 119(a) to French patent application FR2101373 filed on Feb. 12, 2021, the entire teachings of which are incorporated herein by reference.

### FIELD OF THE INVENTION

The present invention relates to the field of anti-money laundering (AML) and more particularly to adaptively managing a degree of AML testing of a transaction.

### DESCRIPTION OF THE RELATED ART

Money laundering is the process of rendering illegally-gained money legal—hence “laundered”. Typically, money laundering involves three steps: placement, layering and integration. First, the illegitimate funds are furtively introduced into the legitimate financial system. Then, the money is moved about the financial system in order to create confusion, sometimes by wiring or transferring funds through numerous, different banking accounts. Finally, the funds are integrated into the financial system through additional transactions until the “dirty money” appears “clean.” As it is well-understood, money laundering can facilitate crimes such as drug trafficking and terrorism, and can adversely impact the global economy.

AML refers to the goal of countering money laundering efforts and specifically respective to the laws, regulations and procedures intended to prevent criminals from disguising illegally obtained funds as legitimate income. Though AML covers a limited range of transactions and criminal behavior, the implications of AML are far-reaching. For example, AML regulations require banks and other financial institutions that issue credit or accept customer deposits to follow rules that ensure they are not aiding money-laundering. In particular, AML regulations require financial institutions to monitor financial transactions of its customers in order to detect and report suspicious financial activity. In order to facilitate the detection of suspicious financial activity, electronic documentation of each transaction oftentimes is submitted to a process in which characteristics of the transaction are determined and compared to a rule detecting an anomaly.

Generally speaking, upon detecting an anomalous condition in a particular transaction, the transaction then can be flagged for manual review by an expert in AML in order to determine whether or not transaction must be reported according to local AML regulations. For a small number of transactions, this is of little consequence, however in a resource constrained organization dealing with a large number of transactions, it is not possible to timely process all transactions flagged for review and, consequently, resource constrained organizations invariably investigate a random subset of the total number of transactions, thus implying that some transactions do not get reviewed by AML experts. Moreover, in AML, time is of the essence.

Thus, a choice must be made between increasing the threshold within the rule beyond which a transaction is flagged for review, thereby risking non-detection of fraudulent transactions, or experiencing delays in reviewing transaction beyond a point at which the transactions can be arrested before completion. Neither choice is palatable from the perspective of compliance with AML regulations.

### BRIEF SUMMARY OF THE INVENTION

Embodiments of the present invention address deficiencies of the art in respect to AML transaction processing and provide a novel and non-obvious method, system and computer program product for adaptable AML transaction analysis. In an embodiment of the invention, a method for adaptable AML transaction analysis includes classifying different resources reviewers in an AML detection system according to experience recorded in connection with reviewing financial transactions to detect legal impropriety. The method also includes determining a resource review capacity for each of the different resource reviewers. Thereafter, a reviewable transaction is received in memory of the AML detection system and a primary AML test is selected for application to the reviewable transaction. The primary AML test is then applied to the reviewable transaction.

In response to a failure of the primary AML test when applied to the reviewable transaction, a magnitude of the failure is computed along with an associated required degree of expertise necessary to review the reviewable transaction based upon the computed magnitude. A triage rule may then be applied to the computed magnitude and degree of expertise and also the resource review capacity of ones of the different resource reviewers classified as having a degree of expertise equal to or greater than the computed required degree of expertise. The triage rule once applied determines whether or not to subject the reviewable transaction to an additional secondary AML test, or to queue the reviewable transaction for resource review by one of the different resource reviewers having the degree of expertise equal to or greater than the required degree of expertise.

In one aspect of the embodiment, the triage rule computes a required degree of expertise as being proportional to the computed magnitude. But oppositely, in another aspect of the embodiment, the triage rule computes a required degree of expertise as being inversely proportional to the computed magnitude. In yet another aspect of the embodiment, the primary AML test is a template document demonstrating a correct transaction such that when the template document is compared to a reviewable transaction, an anomaly as compared to the template document produces a failure condition.

In another embodiment of the invention, a data processing system can be adapted for adaptable AML detection. The system includes a host computing platform having one or more computers, each with memory and at least one processor. The system also includes an adaptable AML detection module. The module includes computer program instructions enabled while executing in the host computing platform to classify different resources reviewers according to experience recorded in connection with reviewing financial transactions to detect legal impropriety, and to determine a resource review capacity for each of the different resource reviewers. Thereafter, a reviewable transaction is received in the memory and a primary AML, test is selected for application to the reviewable transaction. The primary AML test is then applied to the reviewable transaction.

In response to a failure of the primary AML test when applied to the reviewable transaction, the program instructions compute a magnitude of the failure along with an associated required degree of expertise necessary to review the reviewable transaction based upon the computed magnitude. The program instructions then apply a triage rule to the computed magnitude and degree of expertise and also the resource review capacity of ones of the different resource reviewers classified as having a degree of expertise equal to or greater than the computed required degree of expertise. As such, the triage rule once applied determines whether or not to subject the reviewable transaction to an additional secondary AML test, or to queue the reviewable transaction for resource review by one of the different resource reviewers having the degree of expertise equal to or greater than the required degree of expertise.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for adaptable AML, transaction analysis;

FIG. 2 is schematic diagram of a data processing system configured for adaptable AML transaction analysis; and,

FIG. 3 is a flow chart illustrating a process for adaptable AML transaction analysis.

### DETAILED DESCRIPTION OF THE INVENTION

Embodiments of the invention provide for adaptable AML transaction analysis. In accordance with an embodiment of the invention, different resources reviewers in an AML detection system are classified according to the respective experience of each as recorded in connection with the review of financial transactions such that some of the reviewers are considered to have a high degree of expertise owing to extensive recorded experience in reviewing AML transactions to detect impropriety, some considered to have modest experience, and some considered to have low expertise. Thereafter, an availability for each of the reviewers is determined. Then, different AML, transactions received in an AML fraudulent transaction detection system are subjected to a first-tier rule.

To the extent that the application of the first-tier rule to a subject transaction results in a breach, a magnitude of the breach is computed. The, the magnitude of the breach can be correlated to a necessary degree of expertise in a reviewer when reviewing the AML transaction for impropriety. A triage rule is then applied to the computed magnitude and the determined capacity of only of those reviewers having the same or greater than the correlated required degree of expertise. The application of the triage rule determines whether or not to subject the reviewable transaction to an additional secondary AML test, or to queue the reviewable transaction for resource review by one of the different resource reviewers having the degree of expertise equal to or greater than the required degree of expertise.

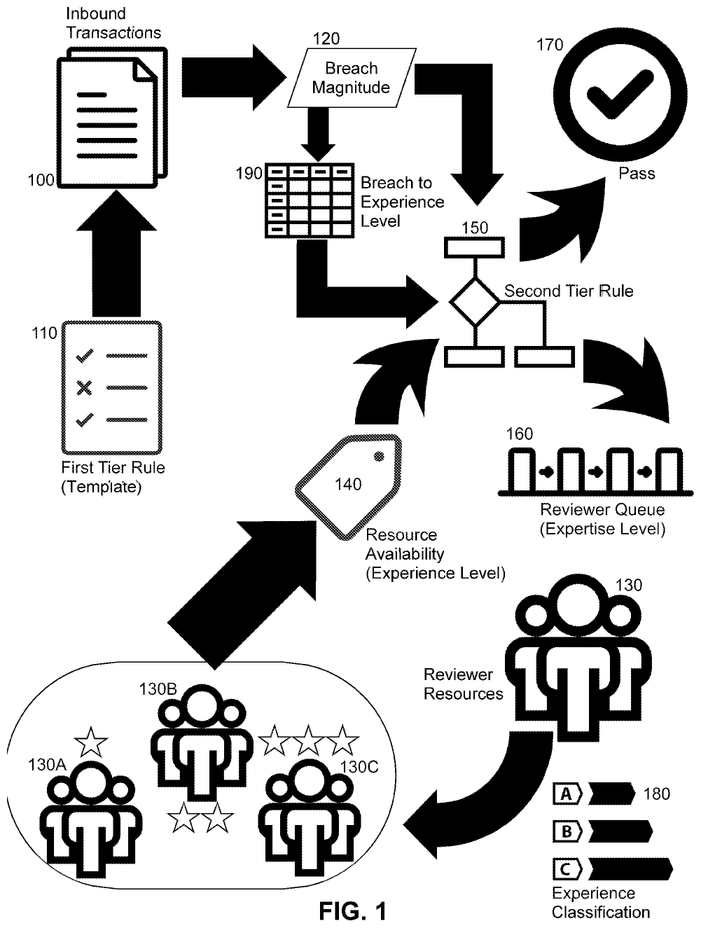

In further illustration, FIG. 1 is pictorial illustration of a process for adaptable AML transaction analysis. As shown in FIG. 1, individual documentation 100 for a corresponding series of financial transactions are subjected to a first-tier rule 110 that may include, for instance, a template of an expected form and expected content of a legitimate transaction. By comparing the expected form and expected content of the legitimate transaction to a subject one of the documentation 100, a breach of the first tier rule 110 may be concluded and a determination of a magnitude of the breach 120 may be provided. The magnitude of the breach 120 can then be correlated to an experience level from a breach table 190 in order to located a degree of experience necessary to review a transaction giving rise to such a breach 120.

Thereafter, a degree of availability 140 of a number of reviewer resources 130 may be determined. Specifically, a pool of reviewer resources 130 may be subjected to a classification 180 according to expertise so as to produce grouping 130A, 130B, 130C of low expertise, average expertise and high expertise. The availability 140 of each of the groupings 130A, 130B, 130C is periodically assessed, for instance, in reference to a reviewers queue for each of the groupings 130A, 130B, 130C, or each of the reviewer resources 130 in each of the groupings 130A, 130B, 130C, or based upon presence awareness for computing devices of each of the reviewer resources 130 in each of the groupings 130A, 130B, 130C, or calendar entries or a task list for each of the reviewer resources 130 in each of the groupings 130A, 130B, 130C. Consequently, once a degree of expertise has been determined according to the breach magnitude 120, a resource availability 140 can be retrieved for ones of the reviewer resources 130 of the degree of experience determined or greater.

The, the degree of availability 140 and the magnitude of the breach 120 may be subjected to a second-tier rule 150. The second-tier rule 150 computes as a function of the degree of availability 140 and the magnitude of the breach 120, a resultant value which, if the resultant value exceeds a threshold, may cause the subject one of the documentation 100 to be enqueued in a queue 160 of suspicious transactions for further analysis by one of the reviewer resources 130. Otherwise, the subject one of the documentation 100 can be considered passable 170 without the need for further review. In this way, each of the inbound transactions 100 can be subjected to review by one of the reviewer resources 130 in an optimized way depending upon the perceived need for a certain level of expertise of the one of the reviewer resources 130 and the availability of reviewer resources 130 at that level of expertise or higher known to have a threshold availability.

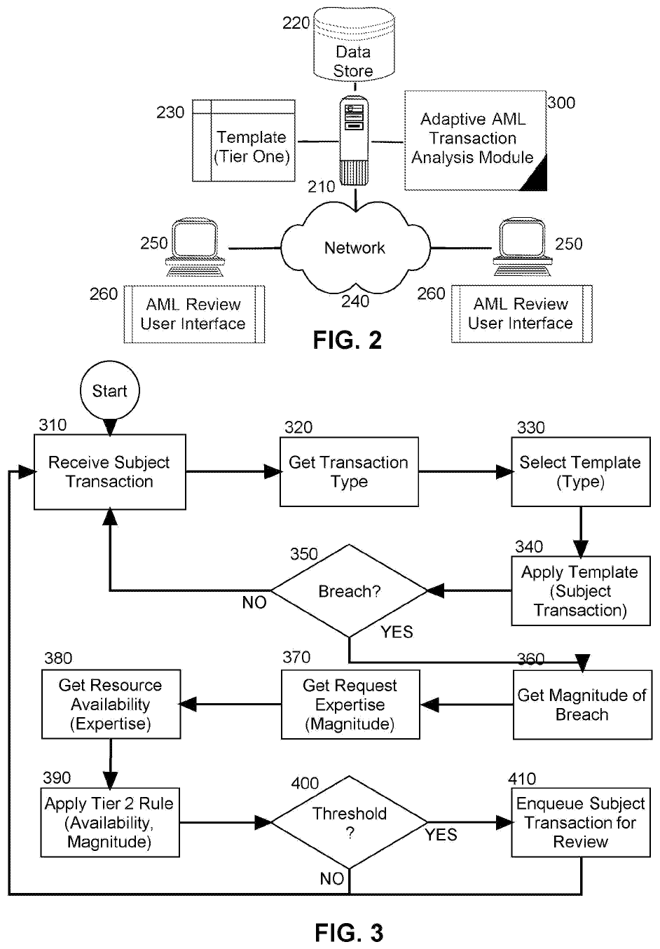

The process described in connection with FIG. 1 can be implemented in a computer data processing system. In further illustration, FIG. 2 schematically shows a data processing system configured for adaptable AML, transaction analysis. The system includes a host computing platform 210 that includes one or more computers, each with memory and at least one processor. The host computing platform 210 includes a data store 220 into which transactions for review are placed and from which the transactions for review are retrieved. The host computing platform 210 also is communicatively coupled over computer communications network 240 to different client computing devices 250, each including an AML review user interface through which suspect transactions may be reviewed for compliance with AML regulations.

Of note, the system also includes an adaptive AML transaction analysis module 300. The module includes computer program instructions enabled during execution in the host computing platform 210 to process each individual transaction in the data store 220 by applying a template of a legitimate transaction 230 to the individual transaction in order to detect anomalies. To the extent that anomalies are detected by the application of the template 230 to the individual transaction, a number of anomalies can be counted in order to produce a magnitude of breach. Then, the program instructions correlate the produced magnitude of breach to a degree of requisite expertise necessary in a reviewer resource to review the individual transaction. In this regard, the expertise can be recorded as an amount of time previously spent reviewing transactions, a quantity of transactions previously reviewed, or an amount of time spent reviewing specific types of transactions or quantity of specific types of transactions previously reviewed.

Concurrently, the program instructions can determine an availability of reviewer resources of the degree of requisite expertise correlated to the produced magnitude of the breach in order to review the suspect transactions. In this regard, the availability of those reviewer resources can be determined based upon information provided by each of the AML, review user interfaces 260 indicating whether or not a corresponding reviewer is overloaded with too many transactions flagged for review, or if the corresponding reviewer is available to review an additional transaction flagged for review based upon a below threshold number of transactions enqueued for review with the reviewer. Thereafter, the program instructions can apply a second-tier rule combining the determined availability and the magnitude or breach in order to compute a value which if such value exceeds a threshold, the subject transaction is then enqueued for further review in one of the AML review user interfaces 260. But otherwise, the transaction is permitted to proceed without further review.

In even yet further illustration of the operation of the adaptive AML transaction analysis module 300, FIG. 3 is a flow chart illustrating a process for adaptable AML transaction analysis. Beginning in block 310, a subject transaction is received for review and in block 320, a transaction type is determined, for instance based upon meta data associated with the transaction. In block 330, a template is retrieved for the determined transaction type and in block 340, the retrieved template is applied to the subject transaction. In decision block 350, it is determined whether or not one or more anomalies (differences) between the template and the subject transaction are detected.

In decision block 350, on account of one or more anomalies having been detected as between the template and the subject transaction, in block 360 a magnitude of the breach—a number of anomalies detected, for instance—can be determined and in block 370, a requisite expertise can be correlated to the breach. For instance, in one aspect of the embodiment, for a large magnitude of breach, a high degree of expertise can be preferred given the number of different anomalies to be reviewed. Alternatively, in another aspect of the embodiment, for a small magnitude of breach, a high degree of expertise can be preferred given the subtlety of the breach requiring a more analytical approach, whereas for a large magnitude of breach, a less analytical approach may be required.

Once the requisite expertise has been determined in correlation with the magnitude of the breach, a resource availability recorded in a data store for all reviewers meeting or exceeding the requisite expertise can be retrieved in block 380. Then, in block 390, a tier-two rule is applied to the resource availability and the magnitude of the breach in order to produce a value. In decision block 400, if the produced value exceeds a threshold, in block 410 the subject transaction is enqueued for further review by a resource reviewer of the same or greater expertise required by the magnitude of the breach. Otherwise, the subject transaction is not subjected to further review and the process repeats through block 310.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for adaptable anti-money laundering (AML) transaction analysis comprising:
classifying different resources reviewers in an AML detection system according to experience recorded in connection with reviewing financial transactions to detect legal impropriety;
determining a resource review capacity for each of the different resource reviewers;
receiving a reviewable transaction in memory of the AML detection system;
selecting a primary AML test for application to the reviewable transaction and applying the primary AML test to the reviewable transaction; and,
responding to a failure of the primary AML test when applied to the reviewable transaction by:
computing a magnitude of the failure and an associated required degree of expertise to review the reviewable transaction based upon the computed magnitude, and
applying a triage rule to the computed magnitude and required degree of expertise to the resource review capacity of ones of the different resource reviewers classified as having a degree of expertise equal to or greater than the computed required degree of expertise to determine whether or not:
to subject the reviewable transaction to an additional secondary AML test, or
to queue the reviewable transaction for resource review by one of the different resource reviewers having the degree of expertise equal to or greater than the required degree of expertise.

2. The method of claim 1, wherein the triage rule computes a required degree of expertise as being proportional to the computed magnitude.

3. The method of claim 2, wherein the triage rule computes a required degree of expertise as being inversely proportional to the computed magnitude.

4. The method of claim 1, wherein the primary AML test is a template document demonstrating a correct transaction such that when the template document is compared to an reviewable transaction, an anomaly as compared to the template document produces a failure condition.

5. The method of claim 1, wherein the determination of a resource review capacity for different resource reviewers in an AML detection system, comprises querying a database record updating an indication of a capacity of individual ones of the different resource reviewers relative to a maximum capacity.

6. A data processing system adapted for adaptable anti-money laundering (AML) transaction analysis, the system comprising:
a host computing platform comprising one or more computers, each comprising memory and at least one processor; and,
an adaptable AML detection module comprising computer program instructions enabled while executing in the host computing platform to perform:
classifying different resources reviewers in an AML detection system according to experience recorded in connection with reviewing financial transactions to detect legal impropriety;
determining a resource review capacity for each of the different resource reviewers;
receiving a reviewable transaction in memory of the AML detection system;
selecting a primary AML test for application to the reviewable transaction and applying the primary AML test to the reviewable transaction; and,
responding to a failure of the primary AML test when applied to the reviewable transaction by:
computing a magnitude of the failure and an associated required degree of expertise to review the reviewable transaction based upon the computed magnitude, and
applying a triage rule to the computed magnitude and required degree of expertise to the resource review capacity of ones of the different resource reviewers classified as having a degree of expertise equal to or greater than the computed required degree of expertise to determine whether or not:
to subject the reviewable transaction to an additional secondary AML test, or
to queue the reviewable transaction for resource review by one of the different resource reviewers having the degree of expertise equal to or greater than the required degree of expertise.

7. The system of claim 6, wherein the triage rule computes a required degree of expertise as being proportional to the computed magnitude.

8. The system of claim 7, wherein the triage rule computes a required degree of expertise as being inversely proportional to the computed magnitude.

9. The system of claim 6, wherein the primary AML test is a template document demonstrating a correct transaction such that when the template document is compared to an reviewable transaction, an anomaly as compared to the template document produces a failure condition.

10. The system of claim 6, wherein the determination of a resource review capacity for different resource reviewers in an AML detection system, comprises querying a database record updating an indication of a capacity of individual ones of the different resource reviewers relative to a maximum capacity.

11. A computer program product for adaptable anti-money laundering (AML) transaction analysis, the computer program product including a computer readable storage medium having program instructions embodied therewith, the program instructions executable by a device to cause the device to perform a method including:
classifying different resources reviewers in an AML detection system according to experience recorded in connection with reviewing financial transactions to detect legal impropriety;
determining a resource review capacity for each of the different resource reviewers;
receiving a reviewable transaction in memory of the AML detection system;
selecting a primary AML test for application to the reviewable transaction and applying the primary AML test to the reviewable transaction; and,
responding to a failure of the primary AML test when applied to the reviewable transaction by:
computing a magnitude of the failure and an associated required degree of expertise to review the reviewable transaction based upon the computed magnitude, and
applying a triage rule to the computed magnitude and required degree of expertise to the resource review capacity of ones of the different resource reviewers classified as having a degree of expertise equal to or greater than the computed required degree of expertise to determine whether or not:
to subject the reviewable transaction to an additional secondary AML test, or
to queue the reviewable transaction for resource review by one of the different resource reviewers having the degree of expertise equal to or greater than the required degree of expertise.

12. The computer program product of claim 11, wherein the triage rule computes a required degree of expertise as being proportional to the computed magnitude.

13. The computer program product of claim 12, wherein the triage rule computes a required degree of expertise as being inversely proportional to the computed magnitude.

14. The computer program product of claim 11, wherein the primary AML test is a template document demonstrating a correct transaction such that when the template document is compared to an reviewable transaction, an anomaly as compared to the template document produces a failure condition.

15. The computer program product of claim 11, wherein the determination of a resource review capacity for different resource reviewers in an AML detection system, comprises querying a database record updating an indication of a capacity of individual ones of the different resource reviewers relative to a maximum capacity.
